(19) United States
(12) Patent Application Publication
(10) Pub. No.: US 2025/0202205 A1
(43) Pub. Date: Jun. 19, 2025

(54) Cable Feeding Device and Method for Retracting Cables into Conduits

(71) Applicant: Robert Bosch GmbH, Stuttgart (DE)

(72) Inventors: Fritz Schlegel, Stuttgart (DE); Andreas Schlegel, Leinfelden-Echterdingen (DE); Mario Ebel, Stuttgart (DE); Timo Bayha, Wolfschlugen (DE)

(21) Appl. No.: 18/975,989

(22) Filed: Dec. 10, 2024

(30) Foreign Application Priority Data
Dec. 14, 2023 (DE) 10 2023 212 717.2

(51) Int. Cl. H02G 1/08

(52) U.S. Cl. CPC H02G 1/081

(57) ABSTRACT

A cable feeding device at least configured for feeding of cables into conduits a pulling device, having at least one pulling device storage unit, in particular, a pulling device drum, for receiving the pulling device, and having a threading unit guiding the pulling device, which, when the pulling device is drawn into the pulling device storage unit, tensions the pulling device, in particular, by winding the pulling device onto the pulling device drum, for example, by braking or pre-tensioning the pulling device drawn toward the pulling device drum by feeding and/or winding. At least one threading element of the threading unit is movably supported along an axis that extends at least substantially perpendicular to a feeding direction of movement of the pulling device into the pulling device storage unit.

This application claims priority under 35 U.S.C. § 119 to application no. DE 10 2023 212 717.2, filed on Dec. 14, 2023 in Germany, the disclosure of which is incorporated herein by reference in its entirety.

### BACKGROUND

A cable feeding device has already been proposed for at least feeding cables into conduits by a pulling means, with at least one pulling means drum for receiving the pulling means, and with a threading unit guiding the pulling means, which is configured to tension the pulling means when the pulling means is wound onto the pulling means drum.

### SUMMARY

The disclosure proceeds from a cable feeding device configured at least to feed cables into conduits by a pulling means, having at least one pulling means storage unit, in particular, a pulling means drum, to receive the pulling means, and having a threading unit guiding the pulling means, which is configured to tension the pulling means when the pulling means is fed into the pulling means storage unit, in particular when the pulling means is wound onto the pulling means drum, for example, by braking or pre-tensioning the pulling means drawn toward the pulling means drum by feeding and/or winding.

It is proposed that at least one threading element of the threading unit is supported movably along an axis that is at least substantially perpendicular to a feeding direction/feeding direction of movement of the pulling means into the pulling means storage unit. In this way, a particularly orderly and/or careful storage, in particular winding up, of the pulling means in the pulling means storage unit can be advantageously enabled. Advantageously, the risk of a faulty operating state or damage to the pulling means, e.g. by tangling and/or knotting the pulling means, can be significantly reduced as a result. Advantageously, the development of a pulling means ball and/or a pulling means entanglement in the pulling means storage unit can be prevented. Advantageously, winding of the pulling means on the pulling means drum in a tight and/or evenly distributed manner over a width of the pulling means drum may be ensured. Advantageously, a space-saving winding can be enabled, in particular due to the fact that the pulling means is wound evenly over the entire width of the pulling means drum. Advantageously, careful and/or orderly storage of the pulling means in the pulling means storage unit can ensure subsequent unwinding of the pulling means without errors.

The cable feeding device is in particular configured as a fish tape pulling system and/or as a cable pulling system. The cable feeding device is in particular provided at least to feed in pulling means, such as fish tapes, cables, or the like. In addition, the cable feeding device may also be provided for dispensing and/or pushing of pulling means, in particular fish tapes, cables, or the like. Pulling means (also: fish tapes or electrician's snakes) are also known in particular as (cable) pull-in tapes and are preferably provided for laying new lines, such as electrical lines, preferably wires, in walls or in cable routings. The pulling means, in particular the fish tape, the cable, or the like, may have a circular cross-section, an oval cross-section, a polygonal cross-section, or a cross-section of a flat tape. Preferably, the cross section of the pulling means is at least substantially constant along a longitudinal extension of the pulling means. The pulling means may also be formed from different materials, for example at least partially from a plastic, such as a nylon, at least partially from a metal, such as from elastic spring steel, at least partially from fiberglass, etc. In particular, “provided” and/or “configured” shall be understood to mean specifically programmed, designed, and/or equipped. In particular, the phrase “an object being provided and/or configured for a specific function” is intended to mean that the object fulfills and/or performs said specific function in at least one application state and/or operating state.

In particular, the pulling means storage unit comprises at least one, preferably drum-shaped, base body that surrounds at least the majority of the pulling means, preferably in a wound-up state. In particular, the base body forms a storage space for the (wound) pulling means. In particular, the pulling means storage unit has a pulling means output at which the pulling means is output to a surrounding environment of the cable feeding device. It is contemplated that the pulling means is stored directly in the storage space formed by the pulling means storage unit, in particular being wound up. However, it is alternatively also conceivable that a support element, e.g. a support cage, is received in an interior of the base body of the pulling means storage unit, which in turn receives the wound-up pulling means in its interior. Preferably, the pulling means storage unit is configured as a pulling means drum, which is either itself mounted in such a way that it can be rotated or which comprises the rotatable support element. In particular, the pulling means can be wound around a drum axis in the pulling means drum. Winding and/or unwinding the pulling means, in particular the pulling means drum and/or the support element, may be carried out manually or by a motorized drive. Advantageously, the cable feeding device comprises a power unit, e.g., an electric motor, or at least one coupling device for coupling to an external power unit, e.g., a hand tool machine. A hand crank may be provided on an outer side of the pulling means storage unit to provide an optional or required manual drive of the pulling means drum or the support element.

The threading unit is provided for threading the pulling means into the pulling means storage unit/onto the pulling means drum, in particular when the pulling means is fed into the pulling means storage unit. The threading unit is preferably disposed outside the pulling means storage unit, in particular outside the base body of the pulling means storage unit. The threading unit is preferably arranged upstream of the pulling means output of the pulling means storage unit. In particular, the threading unit is configured such that a fed portion of pulling means first passes through the threading unit before passing through the pulling means output. Alternatively, however, the threading unit could also be disposed behind the pulling means output and/or within the base body of the pulling means storage unit. In particular, the threading unit comprises only a single threading element. However, it is also contemplated that the threading unit comprises a pair of threading elements that work together and/or that the threading unit comprises two or more consecutive threading elements or pairs of threading elements, in particular which act at least substantially independent from one another. For example, the axis may be formed by a rod that co-rotates with the threading element(s) or about which at least one of the threading elements is rotated. For example, in the case of a pair of threading elements, the threading unit can also have a plurality of rods, e.g., two parallel to each other, each forming an axis. The feeding direction of movement is preferably directed straight towards the pulling means output. The feeding direction of movement is advantageously at least substantially tangential to the pulling means drum/to a winding of the pulling means drum. Preferably, the threading element is supported in an upright/tilt-free manner. Preferably, an orientation of the threading element in space is unaffected/unchanged by the movement of the threading element along the axis. Preferably, threading elements of threading element pairs always and only move together and in a uniform fashion. Instead of threading element pairs or in addition to threading element pairs, threading element trios could also be provided. The expression “substantially perpendicular” is intended in particular to define an orientation of a direction relative to a reference direction, wherein the direction and the reference direction, in particular viewed in a projection plane, enclose an angle of 90° and the angle has a maximum deviation of in particular less than 8°, advantageously less than 5° and particularly advantageously less than 2°.

Further, it is proposed that the threading element is formed as at least one threading roller. Optimal guidance and/or movement control can thus be advantageously achieved, e.g. by braking the threading roller. In particular, the threading roller is provided for braking the pulling means. In particular, the threading roller is provided for tensioning the pulling means. In particular, the threading roller forms a brake roller. In particular, the threading roller forms a tensioning roller. In particular, the threading roller forms a concave running surface for the pulling means. Ideally, the threading element, preferably the threading roller, is placed/connected upstream in a working order of a winding mechanism of the cable feeding device, e.g. the pulling means drum or other feed drive. In particular, the threading element, preferably the threading roller, is provided for tensioning the pulling means during feeding of the pulling means.

Furthermore, it is proposed that the axis along which the threading roller can be moved, in particular along which it can be displaced, runs at least substantially parallel to a winding rotation axis of the pulling means drum and/or to a rotational axis of the threading roller. In this way, a particularly orderly and/or careful storage, in particular winding up, of the pulling means in the pulling means storage unit can be advantageously enabled. In particular, the winding rotation axis is the axis about which the pulling means drum or the rotatable support element of the pulling means drum is rotationally supported. In particular, the winding rotation axis corresponds to a winding axis of the pulling means in the wound state. In particular, the axis of rotation of the threading roller is the axis about which the threading roller is rotationally supported. “Substantially parallel” is to be understood here in particular to mean an orientation of a direction relative to a reference direction, in particular in a plane, wherein the direction has a deviation relative to the reference direction that is in particular less than 8°, advantageously less than 5° and particularly advantageously less than 2°.

In addition, it is proposed that at least the threading element of the threading unit is supported along the axis in such a manner that it can be displaced freely. As a result, the movement of the threading element, in particular the threading roller, along the axis can advantageously be driven by filling the drum, in particular a current filling of the pulling means drum with the pulling means. In this way, a particularly uniform drum filling can advantageously be achieved. Advantageously, the threading unit can be implemented particularly easily and/or cost-effectively. In particular, the threading element has a degree of translational freedom. Preferably, the free displaceability of the threading element is limited on two sides. Preferably, the free displaceability of the threading element is limited to a maximum distance of movement, which corresponds at least substantially to a width of the pulling means drum, in particular to a winding region of the pulling means drum. In this context, a “corresponds at least substantially” is to be understood in particular to mean that the travel distance and the width of the winding region of the pulling means drum differ from one another by less than 50%, preferably by less than 33%, and further preferably by less than 20%.

Alternatively, it is proposed that the cable feeding device comprises a drive unit provided for driving the displacement of at least the threading element of the threading unit along the axis. In this way, it can be advantageously ensured that the pulling means is wound over an entire width of the pulling means drum. Advantageously, a particularly orderly winding of the pulling means can be achieved. For example, the power unit may comprise a spiral on which the threading roller is supported and which drives the movement of the roller along the axis, which is at least substantially perpendicular to a feeding direction of movement of the pulling means into the pulling means storage unit. In this case, for example, the direction of rotation of the spiral may be reversed once an entire range of motion has been traveled along the axis such that the threading roller runs back in the opposite direction. Alternative drives are also contemplated. It is contemplated that the power unit comprises a gear to reverse a rotation of the spiral.

If the power unit comprises the spiral driving the displacement of the threading element of the threading unit, a simple, reliable and/or robust configuration of the power unit can advantageously be achieved.

Further, it is proposed that the threading unit comprises a braking mechanism that works to reduce a rate of movement of the pulling means by the threading unit at least as compared to a current winding speed of the pulling means drum. In this way, a reliable tension of the pulling means can advantageously be achieved, which in particular results in an orderly and/or even winding of the pulling means. Advantageously, tight winding of the pulling means on a drum axis of the pulling means drum can be ensured, whereby a space-saving storage in particular can be achieved. In particular, the braking mechanism reduces a circumferential movement speed of the threading roller, e.g., due to an inhibition of friction of the rotation of the threading roller, in particular as compared to an unbraked threading roller. In particular, a rotation speed of the braked threading roller is always less than a rotation speed of the pulling means drum, in particular the support element of the pulling means drum, corresponding to the winding speed. In particular, the braking mechanism generates a pulling force acting on the pulling means against the feeding direction of movement, which in particular ensures that there is always a tension on the section of the pulling means which is currently arranged between the threading element with the braking mechanism and the pulling means drum/the support element of the pulling means drum.

In principle, the braking mechanism could produce frictional braking of the threading roller, in particular the threading roller could be frictionally braked. However, it is preferred that the braking mechanism function by way of (active) motor braking and/or (passive) gear braking. In this manner, particularly reliable and/or low-wear braking of the threading roller can be achieved. Preferably, the braking mechanism generates motor braking or a gear-induced braking of the rotation of the threading roller.

In addition, it is proposed the threading unit comprises a pre-tensioning mechanism, which is configured to press at least a part of the threading unit, in particular a threading roller of the threading unit or a tensioning roller of the threading unit different from the threading roller, against the pulling means transversely to the pulling means storage unit in a feeding direction of movement of the pulling means, such that the pulling means is deflected from a straight path at least in the area of the threading unit. In this way, an advantageous tension can be generated on the section of the pulling means, which is currently arranged between the threading element with the braking mechanism and the pulling means drum/the support element of the pulling means drum. Advantageously, a particularly tight winding of the pulling means in the pulling means drum and/or a particularly orderly winding of the pulling means in the pulling means drum can be achieved as a result. For example, the pre-tensioning mechanism may comprise a tensioning element, such as the tensioning roller, that pushes on the pulling means transversely to the feeding direction of movement of the pulling means directed toward the pulling means storage unit. The tensioning element, in particular the tensioning roller, can be pre-tensioned, for example by a mechanical spring element or by a gas-pressure spring element. In particular, the tensioning roller may be configured as a spring tensioning roller.

In addition, it is proposed that the threading element of the threading unit is supported along the axis which is at least substantially perpendicular to the feeding direction of movement of the pulling means into the pulling means storage unit in such a manner that it can be displaced in an oscillating manner. In this way, a particularly uniform winding of the pulling means in the pulling means storage unit, preferably the pulling means drum, can advantageously be achieved. Preferably, the threading element is mounted along the axis, which is at least substantially perpendicular to the feeding direction of movement of the pulling means into the pulling means storage unit, in such a way that it can be displaced in an oscillating manner.

Further, a method of feeding cables into conduits by means of the pulling means, in particular by the cable feeding device, is proposed, wherein the pulling means is received into the at least one pulling means storage unit, in particular the pulling means drum, by feeding, and wherein the pulling means is tensioned by the threading unit when the pulling means is drawn into the pulling means storage unit, in particular when the pulling means is rolled onto the pulling means drum, for example, by braking or pre-tensioning the pulling means drawn toward the pulling means drum by feeding and/or winding, wherein the at least one threading element of the threading unit is displaced, preferably in an oscillating manner, during the feeding of the pulling means along the axis, which is at least substantially perpendicular to the feeding direction/feeding direction of movement of the pulling means into the pulling means storage unit. In this way, a particularly orderly and/or careful storage, in particular winding up, of the pulling means in the pulling means storage unit can be advantageously enabled. Advantageously, the risk of a faulty operating state or damage to the pulling means, e.g. by tangling and/or knotting the pulling means, can be significantly reduced as a result.

The cable feeding device according to the disclosure and the method according to the disclosure are not intended to be limited to the application and embodiment described above. In particular, the cable feeding device according to the disclosure and the method according to the disclosure can have a number of individual elements, components and units as well as method steps that differs from a number mentioned herein in order to fulfil an operating mode described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings below. The drawings show exemplary embodiments of the disclosure. The drawings, the description, and the disclosure contain numerous features in combination. A person skilled in the art will appropriately also consider the features individually and combine them into additional advantageous combinations.

The figures show:

FIG. 1a a schematic side view of a cable feeding device with a pulling means and with a threading unit,

FIG. 1b a schematic side view of the cable feeding device with an additional pre-tensioning mechanism,

FIG. 2a a schematic top view of a part of the cable feeding device, wherein the pulling means is completely unwound,

FIG. 2b the schematic top view of the part of the cable feeding device, wherein the pulling means is partially wound,

FIG. 2c the schematic top view of the part of the cable feeding device, wherein the pulling means is further wound than in FIG. 2b, and

FIG. 3 a schematic flowchart of a method with the cable feeding device.

### DETAILED DESCRIPTION

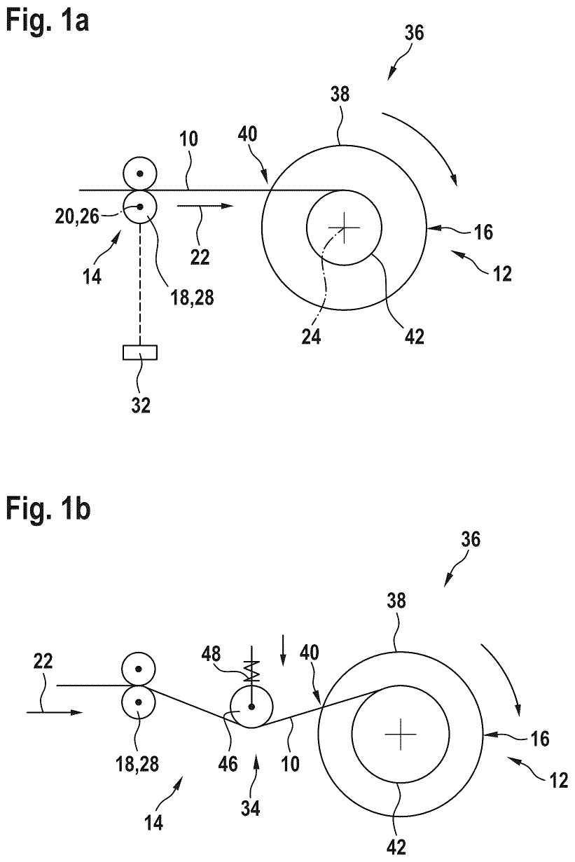

FIG. 1a shows a schematic side view of a cable feeding device 36. The cable feeding device 36 is provided for feeding cables into conduits by a pulling means 10. The pulling means 10 may form an integral part of the cable feeding device 36 or be able to be connected to and/or combined with the cable feeding device 36. The pulling means 10 forms a fish tape. An apparatus for attaching the cable to be fed is provided at a free end of the pulling means 10 (not shown). The cable feeding device 36 comprises a pulling means storage unit 12. The pulling means storage unit 12 is provided for compact storage of the pulling means 10. The pulling means storage unit 12 is configured as a pulling means drum 16. The pulling means drum 16 is provided for receiving the pulling means 10. The pulling means storage unit 12 comprises a base body 38. The base body 38 forms an outer housing. The base body 38 houses at least a large portion of the pulling means 10 stored in the pulling means storage unit 12. The base body 38 comprises a pulling means output 40. The pulling means 10 can be inserted into the base body 38 of the pulling means storage unit 12 via the pulling means output 40. The pulling means 10 can be extended via the pulling means output 40 from the base body 38 of the pulling means storage unit 12.

The pulling means drum 16 comprises a winding element 42. The winding element 42 is formed as a cylindrical, rod-shaped element. The pulling means 10 can be wound on the winding element 42. The pulling means 10 can be unwound from the winding element 42. The winding element 42 is supported in such a manner that it can be rotated. The pulling means drum 16 has a winding rotation axis 24. The winding element 42 of the pulling means drum 16 has the winding rotation axis 24. At least the winding element 42, preferably the pulling means drum 16, is supported in such a manner that it can be rotated about the winding rotation axis 24. Rotation of at least the winding element 42, in particular the pulling means drum 16, generates the movement, in particular a pulling means output movement of the pulling means 10 along an output direction of movement and/or a feeding movement of the pulling means 10 along a feeding direction of movement 22. Depending on the direction of rotation about the winding rotation axis 24, the pulling means 10 is output from/pushed out of the pulling means drum 16 or fed into the pulling means drum 16.

The cable feeding device 36 comprises a threading unit 14. The threading unit 14 is provided to guide the pulling means 10 at least when performing the pulling means feeding movement. The threading unit 14 is provided to tension the pulling means 10 when the pulling means 10 is drawn into the pulling means storage unit 12. The threading unit 14 is provided to tension the pulling means 10 when the pulling means 10 is wound onto the pulling means drum 16. The threading unit 14 is provided to tension the pulling means 10 pulled toward the pulling means drum 16 by way of a braking opposite the feeding movement of the pulling means 10. The threading unit 14 is provided to tension the pulling means 10 drawn towards the pulling means drum 16 by means of a pre-tension acting transversely to the feeding movement of the pulling means 10.

The threading unit 14 comprises a threading element 18. The threading element 18 is formed as a threading roller 28. The threading unit 14 comprises a braking mechanism 32. The braking mechanism 32 works to reduce a rate of movement of the pulling means 10, in particular the rate of movement in a feeding direction of movement 22, as compared to a current winding rate of the pulling means drum 16. The braking mechanism 32 uses motor braking, for example. Alternatively, the braking mechanism 32 could also use gear braking.

FIG. 1b shows cable feeding device 36 in a configuration with a threading unit 14 having a pre-tensioning mechanism 34. The pre-tensioning mechanism 34 is designed to push at least a portion of the threading unit 14 transversely (perpendicularly) towards the feeding direction 22 of the pulling means 10 directed towards the pulling means storage unit 12 against the pulling means 10 such that the pulling means 10 is deflected from a straight path at least in the area of the threading unit 14. The portion of the threading unit 14 forming the pre-tensioning mechanism 34 may be formed by the threading roller 28. Preferably, as shown in FIG. 1b, however, the portion of the threading unit 14 forming the pre-tensioning mechanism 34 is formed by a tensioning roll 46 different from the threading roller 28. The tensioning roller 46 is pre-tensioned by a spring element 48. The pre-tensioning mechanism 34 may be provided in lieu of the braking mechanism 32 or in addition to the braking mechanism 32. The threading roller 28 could also form tensioning roller 46.

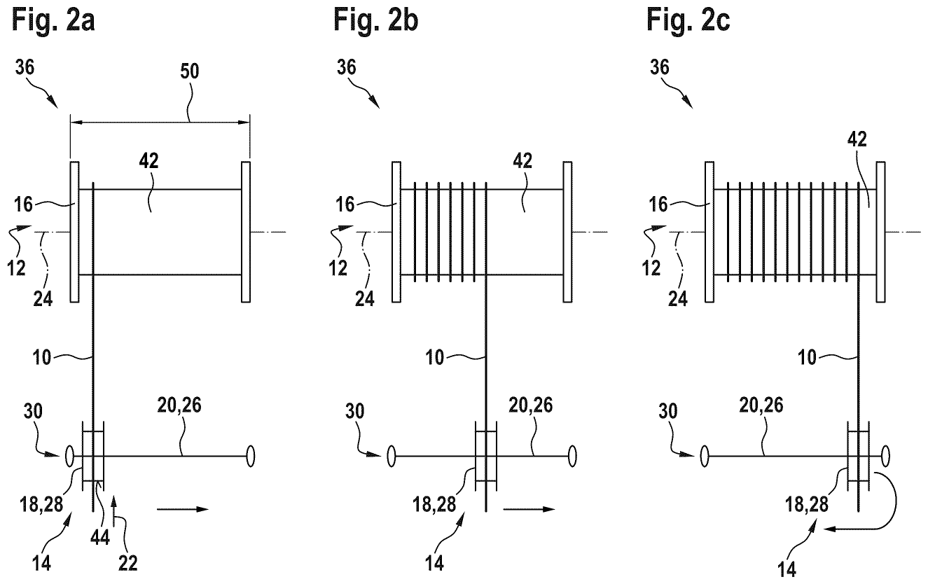

FIGS. 2a to 2c show a schematic top view of a part of the cable feeding device 36. For the sake of clarity, the base body 38 is hidden in FIGS. 2a to 2c.

The threading roller 28 has a concave running surface 44 to prevent the pulling means 10 from easily popping out of the threading roller 28. The threading element 18, in particular the threading roller 28, is supported along an axis 20 in such a manner that it can be moved. The threading element 18, in particular the threading roller 28, is supported along the axis 20 in such a manner that it can slide. The threading element 18, in particular the threading roller 28, is supported along the axis 20 in such a manner that it can oscillate back and forth. The axis 20 is perpendicular to the feeding direction of movement 22 of the pulling means 10. The axis 20 along which the threading roller 28 is supported in such a manner that it can be moved is parallel to the winding rotation axis 24 of the pulling means drum 16, in particular the winding element 42. The threading roller 28 has an axis of rotation 26 about which the threading roller 28 is rotationally supported. The axis of rotation 26 of the threading roller 28 is parallel to the winding rotation axis 24 of the pulling means drum 16, in particular of the winding element 42. The axis 20 along which the threading roller 28 is supported such that it can be moved is parallel to the axis of rotation 26 of the threading roller 28.

The threading element 18 of the threading unit 14 can be supported in such a manner that it can be freely displaced along the axis 20 or can be displaced by an external drive. In the second case, the cable feeding device 36 may comprise a power unit 30, which is provided for driving the displacement of the threading element 18 of the threading unit 14 along the axis 20. If a corresponding power unit 30 is provided, this may comprise a spiral driving the displacement of the threading element 18 of the threading unit 14. In this case, the spiral could be directly formed by the axis 20.

FIGS. 2a to 2c show a motion sequence of the threading unit 14 in which the threading roller 28 is moved along the axis 20 over an entire width 50 of the pulling means drum 16 while the pulling means drum 16 is rotated such that the pulling means 10 is wound onto the pulling means drum 16. The orderly and even winding of the pulling means 10 on the pulling means drum 16 resulting therefrom is also shown schematically. After a complete deceleration of the entire width 50 of the pulling means drum 16, a direction of movement of the threading roller 28 is reversed so that a further layer of the pulling means 10 is wound onto the pulling means drum 16.

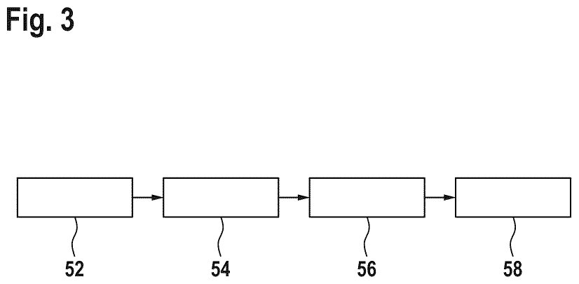

FIG. 3 shows a schematic flowchart of a method for feeding cables into conduits by means of the pulling means 10 via the cable feeding device 36. In at least one method step 52, the pulling means 10 is inserted into a conduit. In at least one further method step 54, the cable is attached to the pulling means 10. In at least one further method step 56, the pulling means 10 is fed in so that the cable is guided through the conduit. The pulling means 10 is thereby gradually fed and received into the pulling means storage unit 12 and rolled up onto the pulling means drum 16. In addition, the pulling means 10 is tensioned during feeding into the pulling means storage unit 12 by the threading unit 14, in that a braking of the pulling means 10 is generated by the threading roller 28 and/or in that a pre-tensioning of the pulling means 10 is generated by the tensioning roller 46. In at least one further method step 58, the threading element 18 of the threading unit 14, in particular the threading roller 28, is moved along the axis 20, which is perpendicular to the feeding direction 22 of the pulling means 10, during the retraction of the pulling means 10. The threading roller 28 performs an oscillating back and forth motion, which may be free or driven.

What is claimed is:

1. A cable feeding device at least for feeding cables into conduits, comprising:
a pulling device;
at least one pulling device storage unit configured to receive the pulling device, wherein the at least one pulling device storage unit comprises a pulling device drum; and
a threading unit configured to guide the pulling device,
wherein
the threading unit is configured to tension the pulling device when the pulling device is wound onto the pulling device drum, such as by braking or pre-tensioning the pulling device drawn toward the pulling device drum by feeding and/or winding, and
at least one threading element of the threading unit is supported, along an axis which is at least substantially perpendicular to a feeding direction of movement of the pulling device into the at least one pulling device storage unit, such that the at least one threading element is displaceable along the axis.

2. The cable feeding device of claim 1, wherein the at least one threading element is formed as at least one threading roller.

3. The cable feeding device of claim 2, wherein the axis along which the at least one threading roller is supported is at least substantially parallel to a winding rotation axis of the pulling device drum and/or to a rotational axis of the at least one threading roller.

4. The cable feeding device according to claim 1, wherein at least the at least one threading element of the threading unit is supported such that the at least one threading element is displaceable freely along the axis.

5. The cable feeding device of claim 1, further comprising:
a power unit configured to drive the displacement of the at least one threading element along the axis.

6. The cable feeding device of claim 5, wherein the power unit comprises a spiral configured to drive the displacement of the at least one threading element.

7. The cable feeding device according to claim 1, wherein the threading unit comprises:
a braking mechanism configured to reduce, from a current winding speed of the pulling device drum, a speed of movement of the pulling device through the threading unit.

8. The cable feeding device of claim 7, wherein the braking mechanism uses motor braking and/or gear braking.

9. The cable feeding device according to claim 1, wherein the threading unit comprises:
a pre-tensioning mechanism configured to press at least one of a threading roller of the threading unit, and a tensioning roller of the threading unit different from the threading roller, against the pulling device transversely to the feeding direction of movement directed toward the at least one pulling device storage unit, such that the pulling device is deflected from a straight path at least in an area of the threading unit.

10. The cable feeding device according to claim 2, wherein the at least one threading element of the threading unit is supported along the axis such that the at least one threading element is displaceable in an oscillating manner.

11. A method for feeding the cables into the conduits using the cable feeding device according to claim 1, comprising:
receiving the pulling device into the pulling device drum of the at least one pulling device storage unit by feeding;
tensioning the pulling device with the threading unit, when the pulling device is fed into the at least one pulling device storage unit by winding the pulling device onto the pulling device drum, by braking or pre-tensioning the pulling device as the pulling device is drawn toward the pulling device drum by feeding and/or winding; and
moving the at least one threading element, during the feeding of the pulling device, along an axis which is at least substantially perpendicular to a feeding direction of movement of the pulling device into the at least one pulling device storage unit.
